(19) United States
(12) Patent Application Publication
(10) Pub. No.: US 2010/0088962 A1
(43) Pub. Date: Apr. 15, 2010

(54) DOOR SAFETY SHIELD

(75) Inventor: Dan McRoskey, Carlsbad, CA (US)

Correspondence Address: KNOBBE MARTENS OLSON & BEAR LLP, 2040 MAIN STREET, FOURTEENTH FLOOR, IRVINE, CA, 92614, US

(73) Assignee: Integrated Capital Properties, LLC, Carlsbad, CA (US)

(21) Appl. No.: 12/250,422

(22) Filed: Oct. 13, 2008

(51) Int. Cl. E06B 7/16; E06B 7/20

(52) U.S. Cl. 49/303; 49/383

(57) ABSTRACT

A door safety shield generally includes a door edge attachment portion, a bridge portion, and a door jamb attachment portion. The door edge attachment portion includes a cornering portion which serves to resist detaching forces on the shield at the door edge caused by forces applied to the shield or opening and closing of the door. The bridge portion includes a tambour panel which moves in a rolling fashion, away from the door's hinge, at least when an external force is applied to the shield. The configuration of the tambour panel serves to prevent injuries between the door and the door jamb, and also serves to resist detaching forces on the shield at the door jamb.

### BACKGROUND OF THE INVENTION

1. Field of the Invention

This application relates generally to a door safety device. More particularly, this application relates to a door safety device for preventing injuries at the hinged side of a hinged door.

2. Description of the Related Art

One of the most common household injuries to people, especially children, involves the crushing or mashing of fingers between the door frame and an edge or surface of a door. The most severe of such injuries tend to occur at the hinged side of the door. The resulting damage may include broken and shattered finger bones, and may even require finger amputations. Various prior art devices are directed at preventing such injuries, including shields designed to bridge the gap between the door and the door jamb.

### SUMMARY OF THE INVENTION

In a first aspect, a door safety shield is provided which includes a door attachment portion, a substantially rigid portion operatively coupled to the door attachment portion, a shield portion operatively coupled to the substantially rigid portion, and a door jamb attachment portion operatively coupled to the shield portion. The door attachment portion includes a door edge portion and a cornering portion. The shield portion is substantially flexible in a first direction and substantially inflexible in a second direction, and is configured to move in a rolling fashion away from a gap between the door and a door jamb at least when an external force is applied to the shield portion. In an embodiment of the first aspect, the cornering portion is configured to transfer detaching forces on the door edge portion to a surface of the door at least when the door is in an open position. In another embodiment of the first aspect, the shield portion is longer than the substantially rigid portion. In a further embodiment of the first aspect, the shield portion comprises a tambour panel comprising a plurality of slats. In a further embodiment of the first aspect, the door edge portion and the cornering portion are hingedly coupled. In a further embodiment of the first aspect, the door edge portion and the cornering portion are fixedly coupled. In a further embodiment of the first aspect, the door safety shield further includes a connecting portion extending between the door attachment portion and the substantially rigid portion such that the substantially rigid portion is movable about the door attachment portion within an arc that is greater than 90°. In such an embodiment, the connecting portion can be hingedly coupled to each of the door attachment portion and the substantially rigid portion.

In a second aspect, a device for preventing injuries between a hinged door and a door jamb at a hinged side of the hinged door is provided. The device includes a door attachment portion configured for attaching to an edge of the door, the edge being generally normal to a plane of the door and located on the hinged side of the door. The device also includes a door jamb attachment portion configured for attaching to a surface of the door jamb, the surface being generally parallel to a plane of the door jamb. The device also includes a substantially rigid portion extending between the door attachment portion and the door jamb attachment portion, the substantially rigid portion being hingedly coupled to the door attachment portion. The device also includes a shield portion hingedly coupled to the door jamb attachment portion and extending toward the substantially rigid portion, the shield portion being configured to move in a rolling fashion as the door moves between an open and a closed position at least when an external force is applied to the shield. In an embodiment of the second aspect, the shield portion comprises an articulated region configured to be substantially flexible in a first direction and substantially inflexible in a second direction. In such an embodiment, the articulated region can comprise a plurality of tambour slats. In another embodiment, the substantially rigid portion can comprise a tambour slat. In another embodiment, the door attachment portion can comprise a door edge portion and a cornering portion. In one embodiment, the cornering portion extends generally normal to the door edge portion at least when the door is in a closed position. In another embodiment, the cornering portion is configured to extend across a portion of a surface of the door at least when the door is in a closed position or a partially open position. In another embodiment, the door edge attachment portion and the cornering portion are movably coupled. In a further embodiment, the door edge attachment portion and the cornering portion are fixedly coupled.

In a third aspect, a door safety shield is provided which includes means for bridging a gap between a door and a door jamb, at least a portion of the bridging means being configured to move in a rolling fashion away from a hinge of the door at least when an external force is applied to the bridging means. The safety shield also includes first means for attaching the bridging means to the door, first means for resisting detaching forces on the first means for attaching, second means for attaching the bridging means to a surface of the door jamb, and second means for resisting detaching forces on the second means for attaching. In an embodiment of the third aspect, the detaching forces on the first means for attaching include shear forces. In another embodiment, the detaching forces on the second means for attaching include normal forces. In another embodiment, the first resisting means comprises a portion of the shield configured to extend across a portion of a surface of the door at least when the door is in an open position. In another embodiment, the second resisting means comprises an articulated region of the shield. In another embodiment, the second resisting means comprises a hinged coupling of the bridging means and the second means for attaching.

In a fourth aspect, a protective shield is provided for a hinged door, the door being attached to a door jamb via a hinge. The protective shield comprises means for inhibiting buildup of static stress within the shield, means for distributing detaching forces resulting from opening and closing of the door to one or more surfaces of the door and/or door jamb;, and means for distributing detaching forces resulting from an external force applied in a direction toward the hinge to one or more surfaces of the door and/or door jamb.

In a fifth aspect, a protective shield is provided for a hinged door, the door being attached to a door jamb via a hinge. The protective shield comprises means for inhibiting buildup of static stress within the shield, means for distributing detaching forces resulting from opening and closing of the door to one or more surfaces of the door and/or door jamb, and means for distributing detaching forces resulting from an external force applied in a direction toward the hinge to one or more surfaces of the door and/or door jamb.

In a sixth aspect, a method of preventing injuries is provided. The method includes providing a bridge configured to span a gap between the door and the door jamb, the bridge comprising a door attachment portion and a door jamb attachment portion. The method also includes attaching the door attachment portion to an edge of the door and attaching the door jamb attachment portion to an attachment surface of the door jamb, wherein at least a portion of the bridge is configured to move in a rolling fashion away from a hinge of the door at least when an external force is applied to the bridge, and wherein at least a portion of the bridge is configured to contact a surface extending normal to the edge at least when the door is in a closed position, and further wherein at least a portion of the bridge is configured to contact a surface of the door jamb extending normal to the attachment surface at least when an external force is applied to the bridge in the direction of the normal surface.

In a seventh aspect, a safety shield is provided for a door hinged to a door jamb, the door having a surface and an edge. The safety shield comprises a door attachment portion comprising a door edge portion and a cornering portion, the door edge portion configured to be attached to the edge of the door, the cornering portion extending generally normal to the door edge portion and across at least a portion of the surface of the door at least when the door is in a closed position. The safety shield also comprises a bridge operatively coupled to the door attachment portion.

### BRIEF DESCRIPTION OF THE DRAWINGS

FIG. 1 shows a perspective view of a door safety shield according to an embodiment.

FIG. 2A shows a top plan view of the door safety shield of FIG. 1, shown in a flattened configuration.

FIG. 2B shows a side view of the door safety shield of FIG. 2A.

FIG. 3A shows a top plan view of a door safety shield according to another embodiment, installed in a door jamb with the door in a closed position.

FIG. 3B shows a top plan view of the door safety shield of FIG. 3A, with the door in a 90° open position.

FIG. 3C shows a top plan view of the door safety shield of FIG. 3A, with the door in a 180° open position.

FIG. 4A shows a perspective view of the door safety shield in the position illustrated in FIG. 3A.

FIG. 4B shows a perspective view of the door safety shield in the position illustrated in FIG. 3B.

FIG. 5 shows a top plan view of a door safety shield according to another embodiment.

FIG. 6 shows a top plan view of a door safety shield according to a further embodiment.

FIG. 7A shows a top plan view of a door safety shield of FIG. 6, installed in a door jamb with the door in a closed position.

FIG. 7B shows a top plan view of the door safety shield of FIG. 6, with the door in a 90° open position.

FIG. 7C shows a top plan view of the door safety shield of FIG. 6, with the door in a 180° open position.

FIG. 8 shows a perspective view of a door safety shield according to an alternative embodiment.

FIG. 9 shows a top plan view of a door safety shield according to an alternative embodiment.

### DETAILED DESCRIPTION OF EMBODIMENTS

The features, aspects and advantages of the development will now be described with reference to the drawings of several embodiments, which are intended to be within the scope of the invention herein disclosed. These and other embodiments will become readily apparent to those skilled in the art from the following detailed description of the embodiments having reference to the attached figures, the invention not being limited to any particular embodiment(s) disclosed.

As mentioned in the Background section, various prior art devices exist which are directed at preventing injuries at the hinged side of a hinged door, including shields designed to bridge the gap between the door and the door jamb. The existing devices have various drawbacks. For example, over time, as a result of repeated opening and closing of the door or of the application of force to the shield, these devices tend to detach from their attachment points on the door and/or the door jamb. In addition, some devices impose a double ply of material between the door and the door jamb when the door is closed, impeding normal closure of the door.

In view of the foregoing, it is an object of the disclosure to provide a safety device for a hinged door having a design which avoids the imposition of stress at the attachment sections when the door is opened and closed and/or when external force is applied to the device after it is attached.

It is another object of the disclosure to provide a safety device for a hinged door having a design which avoids the imposition of a double ply of material between the door and the jamb upon door closure.

It is a further object of the disclosure to provide a safety shield for a hinged door, the installation of which shield is facilitated by having attachment members which are readily lined up with common landmarks on standard hinged door systems.

It is further object of the disclosure to provide a safety device for a hinged door that accommodates door systems involving varying door width dimensions.

It is a further object of the disclosure to provide a safety device for a hinged door having a design which allows the normal (partial or full) opening and closing of the door.

It is a further object of the disclosure to avoid the imposition of any closing or opening force on the door by the installed shield.

Embodiments of the disclosure thus provide a door safety shield of simple and economical construction which offers protection of children's fingers at the hinged side of a hinged door. Embodiments of the disclosure desirably provide a safety shield that is easy to install and that avoids the imposition of stress on the attachment sections when the door is opened and closed. Embodiments also provide a safety shield that avoids the imposition of stress on the attachment sections as the shield blocks a dangerous condition, such as finger or hand being pressed against the shield. Embodiments of the invention also provide a safety shield that can accommodate doors of various widths, that avoids the imposition of a double ply of material between the door and the jamb upon door closure, that allows for the normal opening and closing of the door, that allows for installation with removable attachments such as Velcro as well as more permanent attachments such as screws, and/or that avoids the imposition of closing or opening force on the door by the installed shield. Methods of manufacturing such a shield are also provided.

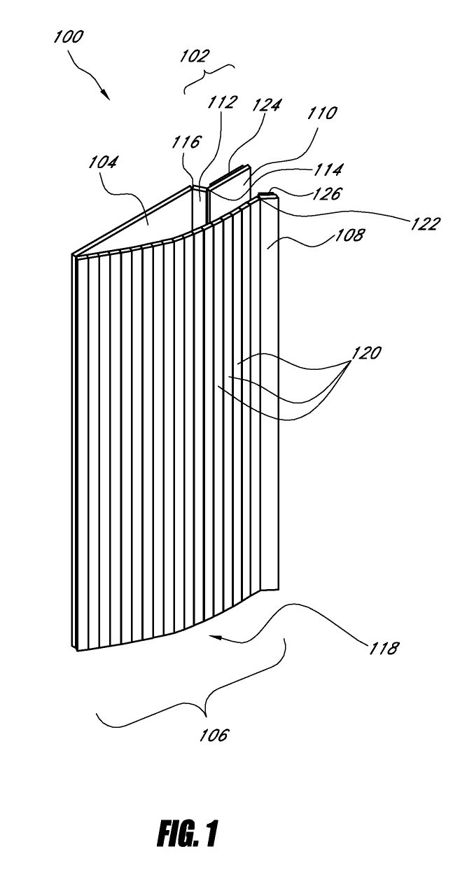

With reference now to FIG. 1, a door safety shield 100 according to an embodiment is illustrated. The safety shield 100 includes a door attachment portion 102, a substantially rigid portion 104, a shield portion 106, and a doorjamb attachment portion 108. The door attachment portion 102 comprises a door edge panel 110 and a cornering panel 112 which are coupled together at a first hinge 114. The cornering panel 112 and the substantially rigid portion 104 are coupled together at a second hinge 116, which can be configured to allow a pivoting action between the hinged parts in an opposing direction to the pivoting action allowed by the first hinge 114. The substantially rigid portion 104 is coupled together with the shield portion 106, which comprises a tambour panel 118 including a plurality of tambour slats 120. The tambour slats 120 are hingedly coupled to one another so as to be pivotable in one direction only (that is, within an arc of about 180°), such that the panel 118 is substantially flexible in one direction but substantially inflexible in the opposite direction.

The substantially rigid portion 104 can be hingedly coupled to the shield portion 106 so as to allow pivoting of the shield portion 106 about the substantially rigid portion 104, in the same direction as the articulations of the shield portion 106. For example, in the illustrated embodiment, the first of the tambour slats 120 is hingedly coupled to the substantially rigid portion 104. Alternatively, the substantially rigid portion 104 can be fixedly coupled to the shield portion 106, in which case the articulations of the shield portion 106 can facilitate a pivoting motion of the shield portion 106 about the substantially rigid portion 104.

The tambour panel 118 is coupled with the door jamb attachment portion 108 at a third hinge 122, which is configured to allow a pivoting action between the hinged parts in an opposing direction to the pivoting action of the tambour slats 120. The door attachment portion 102 can be provided with means for attachment to an edge of a door, such as the illustrated adhesive layer 124, a hook-and-loop fastener, or any other suitable fastening means. The door jamb attachment portion 108 can also be provided with an adhesive layer 126 or other suitable means for attaching to a surface of a doorjamb.

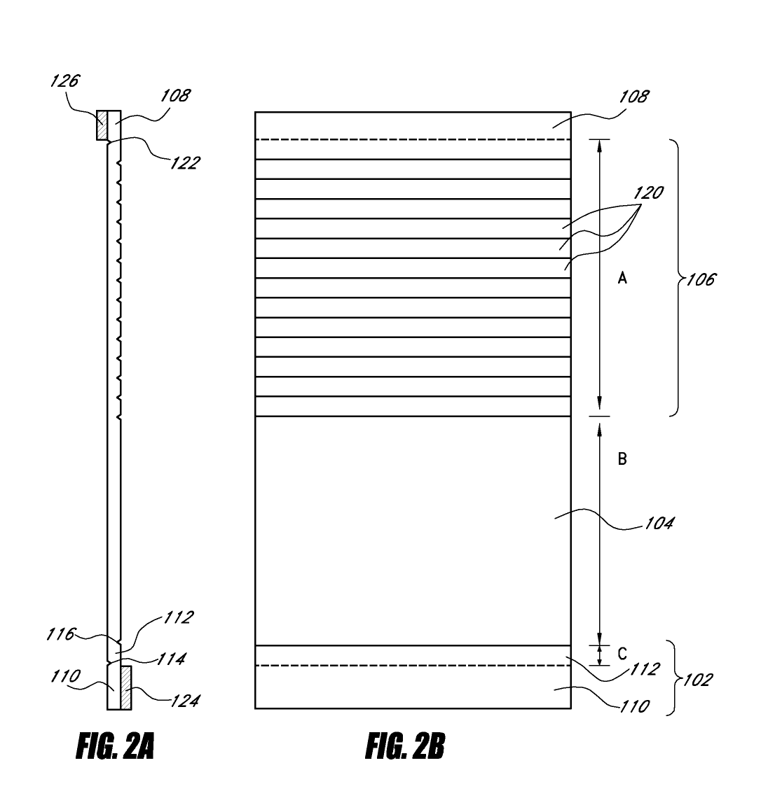

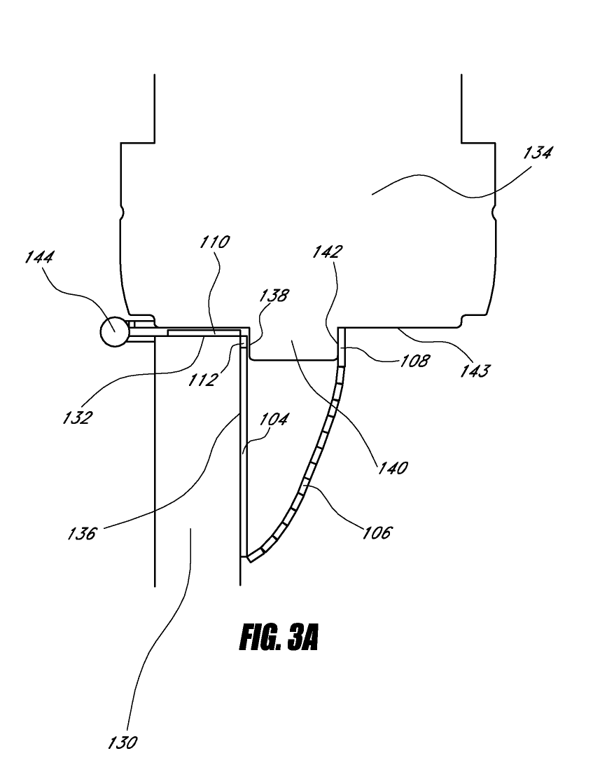

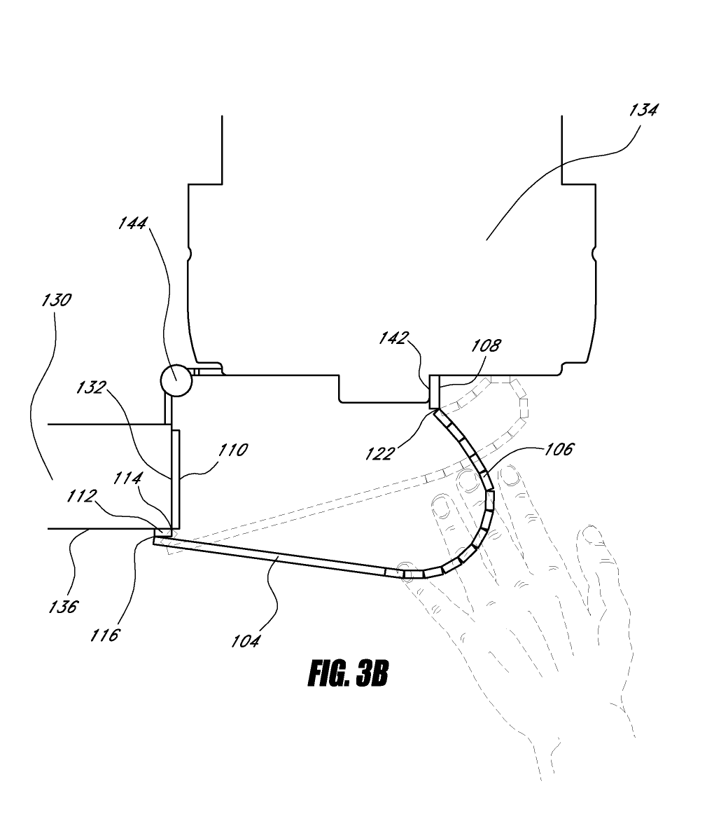

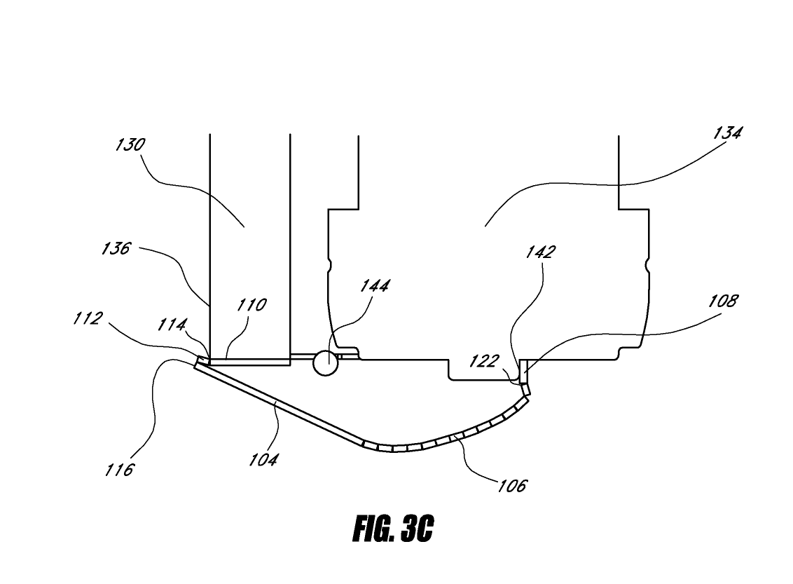

FIGS. 2A and 2B show plan and side views, respectively, of the shield 100 in a flattened configuration, to better illustrate the arrangement of panels and hinge points in the shield 100. As can be seen in the figures, the shield portion 106 has a length A which is at least slightly greater than a length B of the substantially rigid portion. By such a configuration, the shield portion 106 can maintain at least a slight convexity if/when the shield portion 106 is folded back about the substantially rigid portion 104. In some embodiments, the substantially rigid portion can be significantly shorter than the shield portion. For example, in some embodiments, the substantially rigid portion can comprise a tambour slat of the shield portion. In some embodiments, the cornering portion 112 can have a length C which is shorter than a dimension of a door stop near which the shield will be installed, such that, when the shield is installed and the door is closed, at least a portion of the substantially rigid portion 106 is disposed between a surface of the door and the door stop. Such a configuration can increase the tendency of the substantially rigid portion to lay flat against the surface of the door (see, e.g., FIG. 3A).

The operation of the shield 100 is illustrated in FIGS. 3A through 3C, which show the shield 100 installed on a hinged door 130 with the door 130 in closed (FIG. 3A), 90° open (FIG. 3B), and 180° open (FIG. 3C) positions. In the closed position illustrated in FIG. 3A, the door edge portion 110, which is attached to an edge 132 of the door 130, is sandwiched between the door edge 132 and the doorjamb 134. The cornering portion 112 extends roughly normal to the door edge portion 110, and is positioned between a surface 136 of the door 130 and a surface 138 of the door stop 140. The relative positions of the door edge attachment portion 110 and the cornering portion 112 aid in proper positioning of the shield 100 during installation. The substantially rigid portion 104 extends in roughly the same direction as the cornering portion 112, that is, substantially parallel to the surface 136 of the door 130. The substantially rigid portion 104 is hingedly coupled to the shield portion 106, which extends back toward the door stop 140. The shield portion 106 is hingedly coupled to the door jamb attachment portion 108, which is attached to a surface 142 of the door stop 140, opposite the surface 138. Upon installation, an end of the doorjamb attachment portion 108 abuts a surface 143 of the doorjamb 134 extending normal to the surface 142. Such a configuration helps to distribute shear forces on the attachment portion 108 to the surface 143 of the door jamb 134. The configuration of the door jamb attachment portion 108 also serves to aid in proper positioning of the shield 100 during installation. As can be seen in FIG. 3A, in the illustrated closed position, only a single layer of shield material is imposed between the door 130 and the doorjamb 134. Also, in the closed position, the substantially rigid portion 104 is for the most part hidden from view, as it is tucked back behind the shield portion 106.

As the door 130 opens from a closed position, the substantially rigid portion 104 pivots about the second hinge 116 and moves away from the surface 136 of the door 130. In addition, the shield portion 106 moves in a rolling fashion away from the door hinge 144, in a direction generally normal to the surface 142 to which the door attachment portion 108 is attached. As illustrated in FIG. 3B, when the door 130 is in a 90° open position, the substantially rigid portion 104 is folded back about the cornering portion 112. The substantially rigid portion 104 and the shield portion 106 cooperate to bridge the gap between the door edge 132 and the door jamb 134. As the articulations of the shield portion 106 are configured to bend significantly in only a single direction, the shield portion 106 can easily assume a convex curvature between the surface of the door and the door jamb, but remains flat (or only slightly concave) when a force is applied in the direction of the hinge. Thus, the configuration of the shield 100 prevents entry of a hand or finger into the gap. Instead, a force applied against the shield portion 106 in the direction of the hinge 144 (to the left, in the figure) will result in a general flattening of the shield portion 106 and the movement of the substantially rigid portion 104 away from the hinge (in a downward direction, in the figure). A force applied against the shield portion 106 in the direction of the door jamb 134 (in an upward direction, in the figure) will increase the curvature of the articulations of the shield portion 106 and cause at least some of the shield portion 106 to move in a rolling fashion away from the gap. The shield portion 106 thus acts as a “tractor tread” to prevent entry of a finger or hand into the dangerous gap.

The configuration of the shield 100 also serves to resist detaching forces on the attachment portions 108, 102 due to external forces applied to the shield. As illustrated in dashed lines in FIG. 3B, in response to a force applied in the direction of the hinge 144 and/or the door jamb 134, the cornering portion 112 can move away from the surface 136 of the door, while still extending across a portion of the surface 136 of the door, and allowing the substantially rigid portion 104 to angle back toward the door jamb 134. Further, the curvature of at least part of the shield portion 106 will increase as it moves toward, and eventually contacts, the surface 143 of the door jamb. When the shield 100 is pushed toward the gap (to the left or in an upward direction, in the figure), detaching forces on the attachment portion 108 (that is, forces tending to pull the attachment portion 108 away from the surface 142) are limited by the pivoting movement of the shield portion 106 about the hinge 122. Similarly, detaching forces on the attachment portion 102 (that is, forces tending to pull the attachment portion 102 away from the surface 132) are limited by the pivoting movement of the substantially rigid portion 104 about the hinge 116, as well as by the cornering portion 112 which transfers loads to the surface 136 of the door. The hinges 114, 116, and 122, along with the articulations of the shield portion 106, also cooperate to resist detaching forces on the attachment portions 108, 102 caused by opening and closing of the door.

Turning now to FIG. 3C, the shield 100 continues to bridge the gap between the door 130 and the door jamb 134 even as the door 130 opens to a 180° open position. In the illustrated embodiment, a full (in this case, 180°) opening of the door is facilitated by the hinge 114, which allows the cornering portion 112 to pivot so as to extend substantially in line with the door edge attachment portion 110, such that the substantially rigid portion 104 extends back toward the door jamb 134 to bridge the gap. As described above in connection with FIG. 3B, the configuration of the shield 100 serves to prevent entry of a finger or hand into the gap between the door 130 and the door jamb 134. In addition, the configuration of the shield 100 serves to limit or reduce detaching forces on the attachment portions 102, 108 due to opening and closing of the door, and/or external forces applied to the shield 100.

The configuration of the door attachment portion 102 and the door jamb attachment portion 108, in combination with the placement and configuration of the hinges 114, 116, and 122, serves to create a “moving bridge” between the door 130 and the door jamb 134. As the door is opened and closed, and/or as external forces are applied to the installed shield 100, the abutments of the “bridge” shift their respective positions on the door and the door jamb. Forces that might otherwise result in shear or pulling forces on the attachment portions 102, 108 are distributed to result in normal forces on the door edge or door surface 136 (due at least in part to the configuration of the cornering portion 112 and the substantially rigid portion 104) and/or the door jamb 134 (due at least in part to the abutment of the door jamb attachment portion against the door jamb 134, and/or the contact of the shield portion 106 against the door jamb 134 if/when the shield portion 106 is pressed against the doorjamb 134). Further, the configuration of the shield 100, including the shield portion 106 and the hinges 114, 116, and 122, serves to reduce static stresses in the shield 100, thereby reducing detaching forces that might otherwise result from those static stresses.

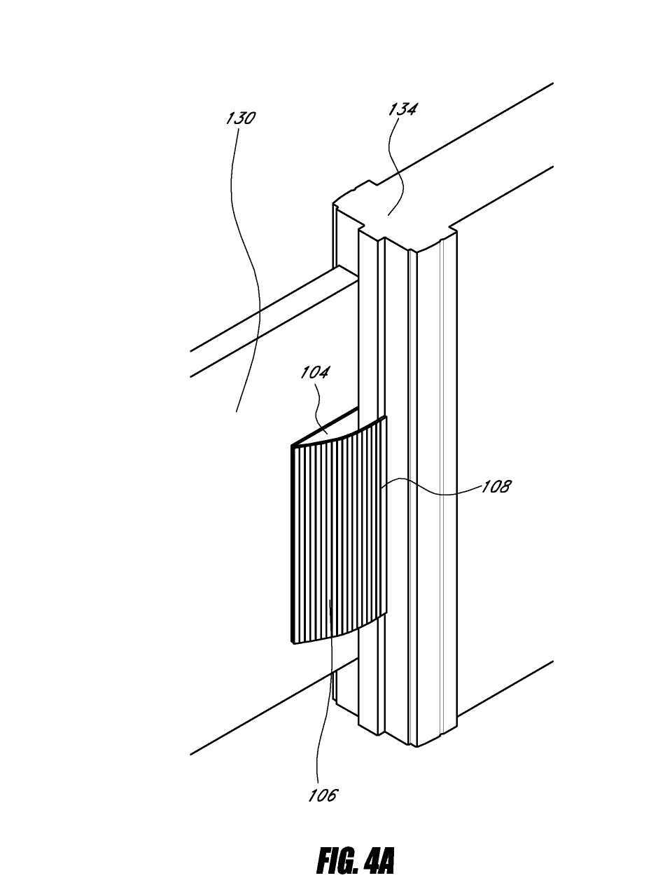

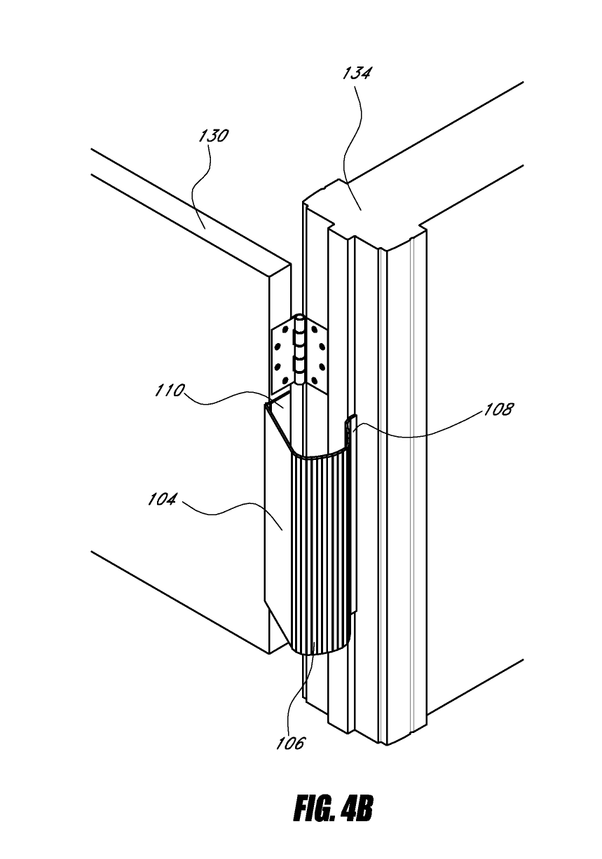

FIGS. 4A and 4B show perspective views of the installed shield 100 with the door 130 in closed and opened positions, respectively. As can be seen in FIG. 4A, when the door 130 is in the closed position, the substantially rigid portion 104 is for the most part hidden from view, as it is tucked back against the surface of the door 130, behind the shield portion 106. In the open position shown in FIG. 4B, the substantially rigid portion 104 moves away from the surface of the door 130, pivoting about the hinge 116. At the same time, the shield portion 106 moves in a rolling fashion to bridge the gap created between the door 130 and the door jamb 134.

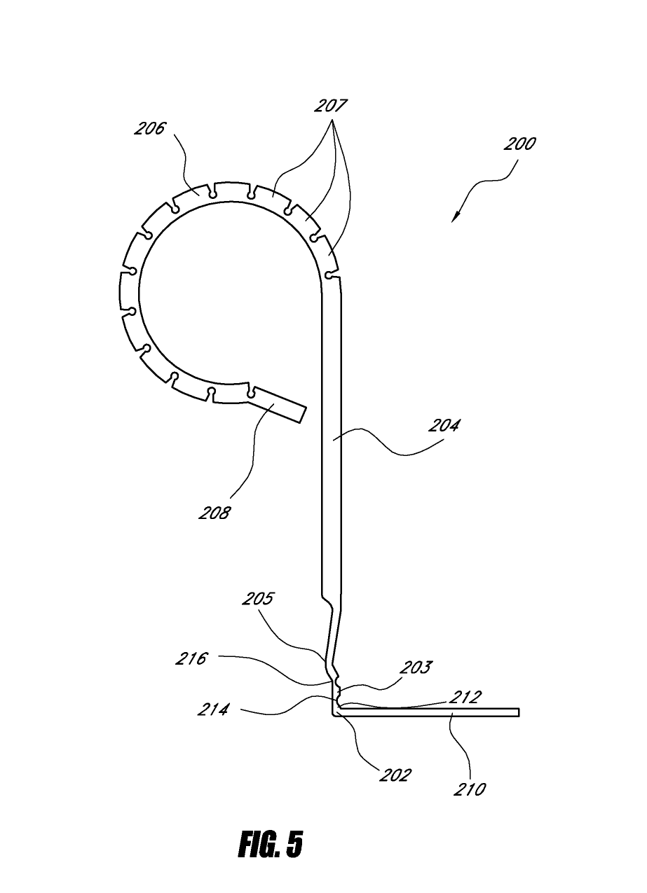

A shield 200 according to an alternative embodiment is illustrated in FIG. 5. The shield 200 includes a door attachment portion 202, a substantially rigid portion 204, an articulating portion 206, and a door jamb attachment portion 208. The articulating portion 206 includes a plurality of jointed panels 207 which are hingedly coupled to each other such that the articulating portion 206 is substantially flexible in only a single direction. In some embodiments, some or all of the panels 207 can include one or more features configured to “pre-load” the articulating portion 206 and maintain at least a slight convexity in the portion 206. Such a feature can comprise, for example, protrusions extending from one or both sides of each panel. Further, in some embodiments, some or all of the panels 207 can include one or more features configured to inhibit or prevent collapse of two panels against each other. Such a feature can comprise, for example, one or more protrusions extending from a rear surface (that is, a surface facing the door hinge when the shield is installed) of one or more panels. Of course, as will be understood by one of skill in the art, any other suitable features can be included to achieve these functions.

As can be seen in the figure, the articulating portion 206 and the door jamb attachment portion 208 are hingedly coupled such that the joint between the two parts is flexible in the opposite direction. The door attachment portion 202 comprises a door edge panel 210 and a cornering panel 212 which extends in a generally perpendicular direction from the door edge panel 210. In the illustrated embodiment, the door edge panel 210 and the cornering panel 212 are fixedly coupled. The door attachment portion 202 and the substantially rigid portion 204 are operatively coupled via a connecting portion 203. The connecting portion 203 is pivotably coupled to the door attachment portion 202 at hinge 214 and pivotably coupled to the substantially rigid portion 204 at hinge 216. Either or both of the hinges 214, 216 can be configured to allow pivoting of their respective parts in a single direction only (that is, within an arc of about 180°), or can be configured as two-way hinges (allowing up to about a 360° range of motion). Of course, either or both of the hinges 214, 216 can be configured to allow pivoting of their respective parts within any suitable range of motion. In the illustrated embodiment, the substantially rigid portion 204 includes a curved portion 205 which can be configured to help define the range of motion of the substantially rigid portion 204 about the connecting portion 203. The curved portion 205 can also be configured to reinforce the tendency of the substantially rigid portion 204 to lay flat against the surface of the door when the door is closed.

With reference now to FIG. 6, a shield 300 according to a further embodiment is illustrated. The shield 300 includes a door attachment portion 302, a substantially rigid portion 304, an articulating portion 306, and a door jamb attachment portion 308. The articulating portion 306 includes a plurality of jointed panels 307 which are hingedly coupled to each other such that the articulating portion 306 is substantially flexible in only a single direction. As can be seen in the figure, the articulating portion 306 and the door jamb attachment portion 308 are hingedly coupled such that the joint between the two parts is flexible in the opposite direction. The door attachment portion 302 comprises a door edge panel 310 and a cornering panel 312 which extend in a generally perpendicular direction from one another. In the illustrated embodiment, the door edge panel 310 and the cornering panel 312 are fixedly coupled. The door edge panel 310 and the cornering panel 312 can be of a unitary construction, or can comprise separate parts which are coupled together. The door attachment portion 302 and the substantially rigid portion 304 are operatively coupled via a connecting portion 303. The connecting portion 303 is pivotably coupled to the door attachment portion 302 at hinge 314 and pivotably coupled to the substantially rigid portion 304 at hinge 316. Either or both of the hinges 314, 316 can be configured to allow pivoting of their respective parts in a single direction only (that is, within an arc of about 180°). Of course, either or both of the hinges 314, 316 can be configured to allow pivoting of their respective parts within any suitable range of motion. In the illustrated embodiment, the substantially rigid portion 304 includes a curved portion 305 which is configured to help define the range of motion of the substantially rigid portion 304 about the connecting portion 303.

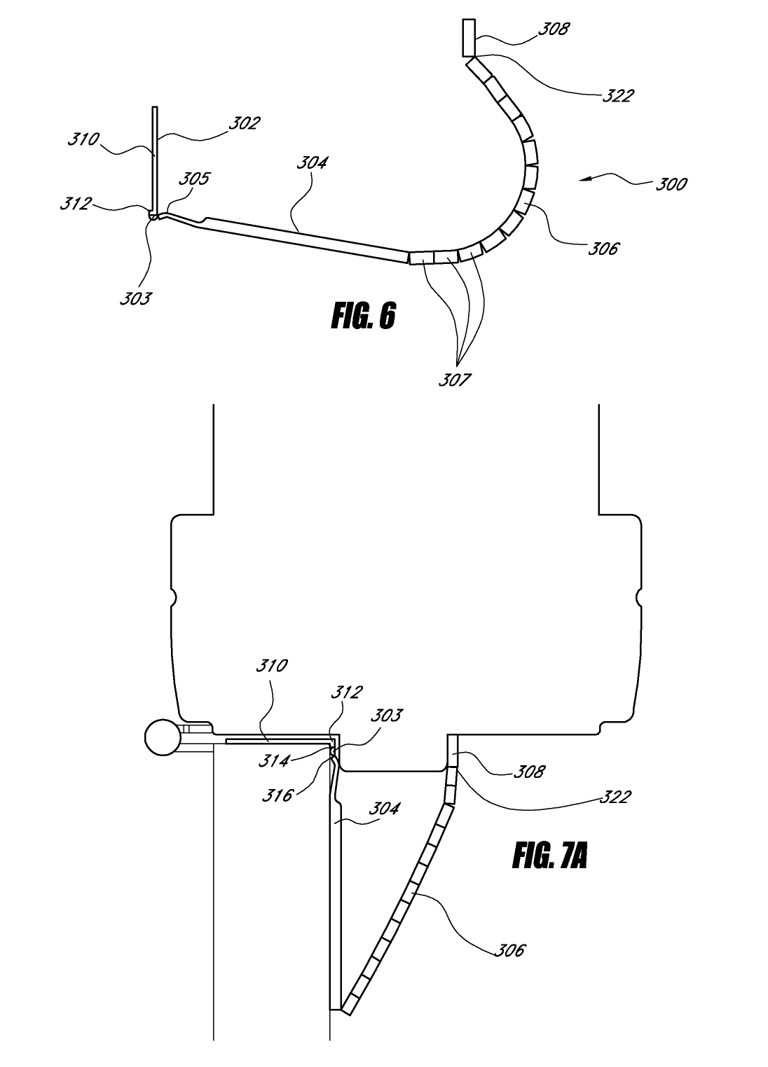

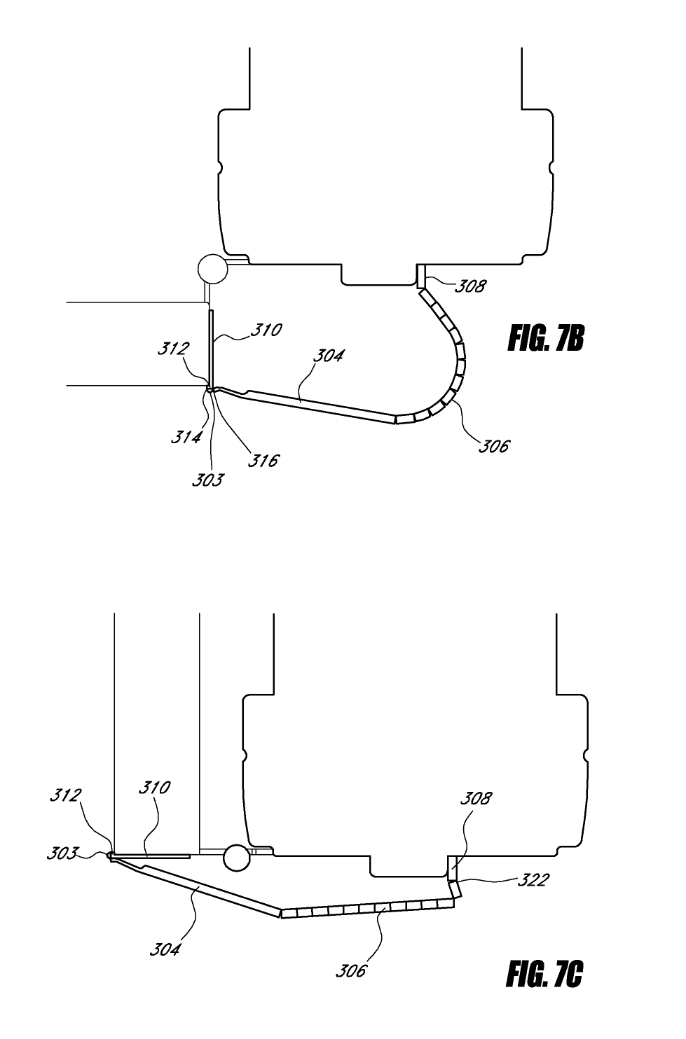

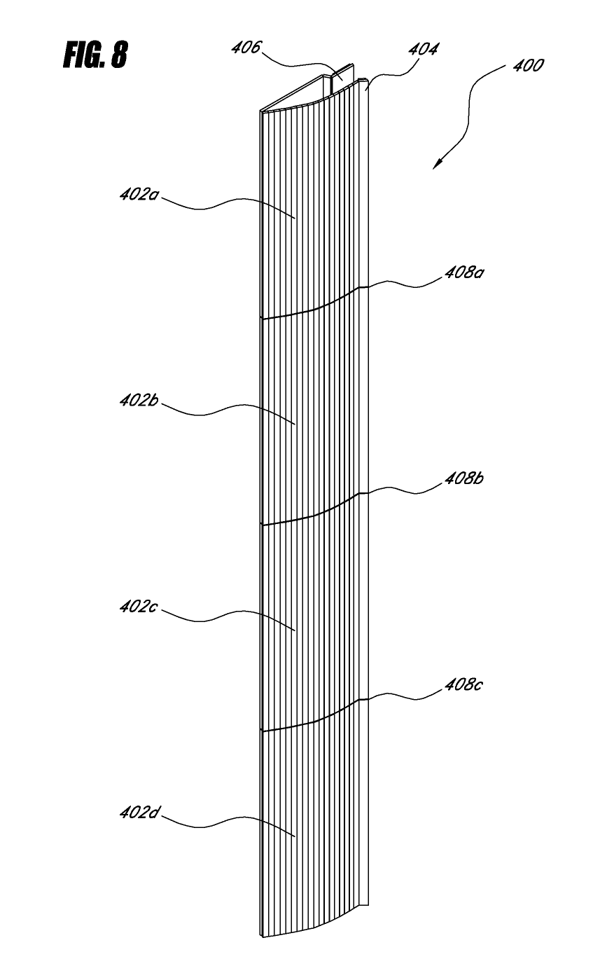

The operation of the shield 300 is illustrated in FIGS. 7A through 7C, which show the shield 300 installed on a hinged door with the door in closed (FIG. 7A), 90° open (FIG. 7B), and 180° open (FIG. 7C) positions. In the closed position illustrated in FIG. 7A, the door edge portion 310, which is attached to an edge of the door, is sandwiched between the door edge and the door jamb. The cornering portion 312 extends roughly normal to the door edge portion 310, and is positioned between a surface of the door and a surface of the door stop. The connecting portion 303 extends in roughly the same direction from the cornering portion 312, that is, substantially parallel to the surface of the door, and is also positioned between the surface of the door and the surface of the door stop. The substantially rigid portion 304 is hingedly coupled at a first end to the connecting portion 303, and extends in roughly the same direction, at least when the door is in the illustrated closed position. The substantially rigid portion 304 is hingedly coupled at its second end to the articulating portion 306, which extends from the substantially rigid portion 304 back toward the door stop. The articulating portion 306 is hingedly coupled to the door jamb attachment portion 308, which is attached to a surface of the door jamb opposite the surface facing the cornering portion 312 and the connecting portion 303. As can be seen in FIG. 7A, in the illustrated closed position, only a single layer of shield material is imposed between the door and the door jamb. Also, in the closed position, the substantially rigid portion 304 is tucked back behind the articulating portion 306.

As the door opens from a closed position, the connecting portion 303 can pivot about the hinge 314. The substantially rigid portion 304 can also pivot about the hinge 316. By such a configuration, the substantially rigid portion 304 can move away from the surface of the door as the door opens from a closed position. At the same time, the articulating portion 306 can move in a rolling fashion about the gap between the door and the door jamb.

As illustrated in FIG. 7B, when the door is in a 90° open position, the substantially rigid portion 304 is folded back about the cornering portion 312, with the aid of the connecting portion 303. The substantially rigid portion 304 and the articulating portion 306 cooperate to bridge the gap between the door edge and the door jamb. As the articulations of the articulating portion 306 are configured to bend significantly in only a single direction, the configuration of the shield 300 prevents entry of a hand or finger into the gap. Instead, a force applied against the articulating portion 306 in the direction of the door hinge (to the left, in the figure) will result in a general flattening of the articulating portion 306 and the movement of the substantially rigid portion 304 away from the hinge (in a downward direction, in the figure). A force applied against the articulating portion 306 in the direction of the door jamb (in an upward direction, in the figure) will increase the curvature of the articulations of the articulating portion 306 and cause at least some of the articulating portion 306 to move in a rolling fashion about the gap.

The configuration of the shield 300 also serves to resist detaching forces on the attachment portions 308, 302 due to external forces applied to the shield. For example, when the shield 300 is pushed toward the gap (to the left or in an upward direction, in the figure), detaching forces on the attachment portion 308 (that is, forces tending to pull the attachment portion 308 away from the surface of the door stop to which it is attached) are limited by the pivoting movement of the articulating portion 306 about the hinge 322. Similarly, detaching forces on the attachment portion 302 (that is, forces tending to pull the attachment portion 302 away from the edge of the door) are limited by the pivoting movement of the connecting portion about the hinge 314, the pivoting movement of the substantially rigid portion 304 about the hinge 316, as well as by the configuration of the cornering portion 312 which transfers loads to the surface of the door. The hinges 314, 316, and 322, along with the articulations of the articulating portion 306, also cooperate to resist detaching forces on the attachment portions 308, 302 caused by opening and closing of the door.

Turning now to FIG. 7C, the shield 300 continues to bridge the gap between the door and the door jamb even as the door opens to a 180° open position. In the illustrated embodiment, a full (in this case, 180°) opening of the door is facilitated by the connecting portion 303 and the hinges 314, 316, which allow the substantially rigid portion 304 to pivot about the door edge attachment portion 310 and extend back toward the door jamb to bridge the gap. As described above in connection with FIG. 7B, the configuration of the shield 300 serves to prevent entry of a finger or hand into the gap between the door and the doorjamb. In addition, the configuration of the shield 300 serves to limit or reduce detaching forces on the attachment portions 302, 308 due to opening and closing of the door, and/or external forces applied to the shield 300.

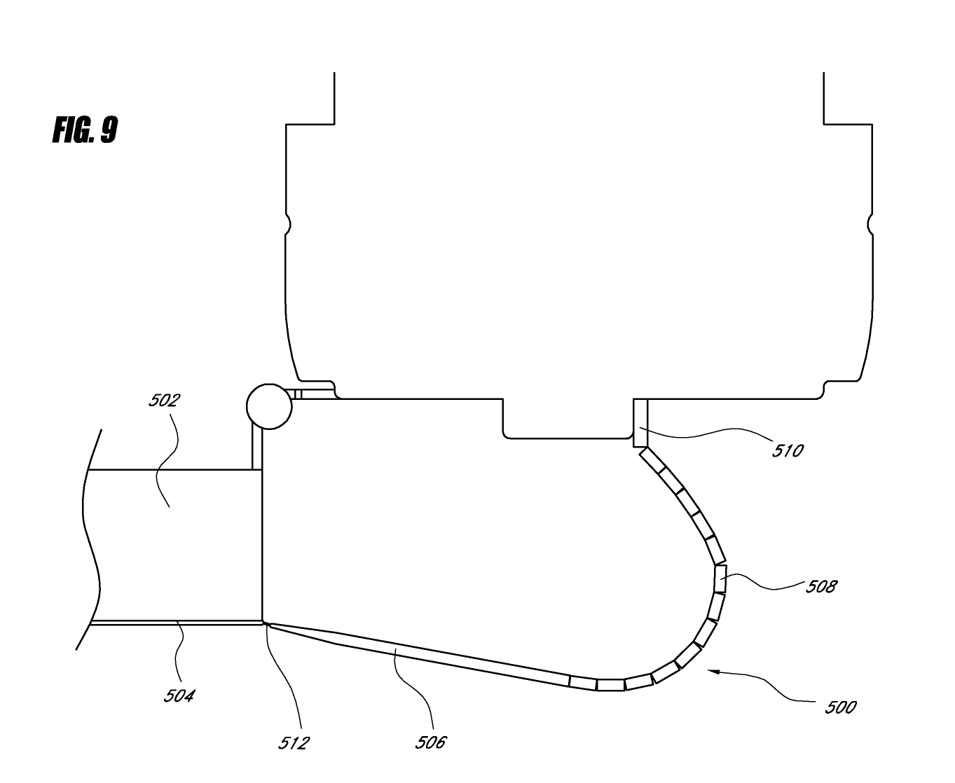

In some embodiments, a shield and/or any portions thereof can be configured with any suitable dimensions and adapted for use with doors of varying widths and heights. Shields of a relatively shorter dimension, for example, can be installed in households with only very small children, and can be installed at heights where injury is most likely to occur. Shields of a relatively taller dimension can be used in applications where injuries are desirably prevented over a larger span. One such embodiment is illustrated in FIG. 8, which shows a safety shield 400 according to an embodiment. The shield 400 can be adapted to cover a larger height than the previously illustrated embodiments. The shield 400 includes a series of shield sections 402(a)-402(d), each of which can be configured substantially as described herein, with a door jamb attachment section 404 and a door edge attachment section 406. The shield sections 402(a)-402(d) are coupled together at horizontal joints 408(a)-408(c), which can be configured to allow folding of the panels against each other for ease of packaging and transporting the shield 400.

With reference now to FIG. 9, a shield 500 according to a further embodiment is illustrated. The shield 500 is an extension of a portion of a door 502, and includes a door panel 504, a substantially rigid portion 506, an articulating portion 508, and a door jamb attachment portion 510. The door 502 can have a laminate construction, and the door panel 504 can be a layer of the door 502, such as a surface layer or a layer underneath the door's surface. Of course, the door panel 504 can be attached to the door 502 in any other suitable manner. The door panel 504 extends beyond the door 502 into the substantially rigid portion 506, with the joint 512 between the two parts scored, molded, or otherwise configured to create a living hinge between the two parts, so as to allow pivoting of the substantially rigid portion 506 about the door panel 504 as the door opens and closes (and as pressure is applied to the substantially rigid portion 506 or the articulating portion 510). The articulating portion 508 and door jamb attachment portion 510 extend from the substantially rigid portion, and can be configured substantially as described herein. The shield 500 can be manufactured and supplied as part of the door 502 if desired, and can be configured to extend along part or all of the door's height.

In some embodiments, a shield can be configured to allow substantially normal opening and closing of a door which normally opens to a 180° position. In other embodiments, a shield can be adapted for a door which normally opens to only a 90° position. In further embodiments, a shield can be adapted for a swinging door which opens into and out of a room.

In these and other embodiments, a shield and/or any portions thereof can comprise any suitable material, including but not limited to a rigid or semi-rigid plastic, wood, metal, or composite material. The shield can have an essentially unitary construction, or can be comprised of separate portions which are joined together in any suitable fashion. The shield can be formed from a single flat sheet of material (see, for example, FIGS. 2A and 2B), or can comprise one or more molded or extruded portions of any suitable cross section (see, for example, FIGS. 5 and 6).

The articulated portion can have any suitable construction which allows it to flex substantially in a single direction, but which prevents it from flexing significantly in the opposite direction. For example, the articulated portion can be formed from a single layer of material which has been scored on one side to create articulations. (See, for example, FIGS. 2A and 2B). Alternatively, the articulated portion can be formed from layer of a first material which is adhered to (or otherwise affixed to) a backing layer comprising a flexible material, such as a flexible fabric. The first material can be scored on the side opposite the backing layer, and then the layers can be rolled to break the scores and separate the first material into a series of closely-abutting panels. In such an embodiment, a minute separation between each panel would allow the articulated portion to flex in one direction, but flexibility in the other direction would be limited or prevented by the abutment of each panel against its neighboring panel. In another alternative, the articulated portion can be formed from a plurality of narrow panels which are adhered to (or otherwise affixed to) a backing layer in close proximity to one another. In other embodiments, the articulated portion can comprise a series of interlocking panels, with the joints between each panel configured to allow the desired flexibility in only a single direction.

Similarly, the hinge points between each portion of the shield can have any suitable construction which provides the desired range of motion for the particular hinged portions. For example, some or all of the hinge points can be formed in a similar manner as the articulations described above, taking into account the desired direction or range of flexibility of the hinged portions as described herein. Further, although the illustrated embodiments include shields configured for attachment to a surface of a door stop which extends generally parallel to a surface of a door in the closed position, embodiments can of course be configured for attachment to other surfaces of the door jamb, with hinge points adjusted to facilitate (or limit) the desired (or unwanted) flexibility and/or range of motion as described herein. Embodiments of the invention also include methods of manufacturing a safety shield generally as described herein.

In addition, shields according to embodiments of the invention can be configured for any suitable manner of attachment to a door and door jamb. For example, the door edge attachment portion and/or the door jamb attachment portion can be configured with an adhesive layer or a hook-and-loop fastener strip for removable or semi-permanent attachment to their respective surfaces on the door and door jamb. Of course, if desired, embodiments can be configured for more permanent attachment, for example with screws. Because the door attachment portion is configured for attachment to an edge of the door, more permanent attachment will not mar the face of the door. The configuration of the shield facilitates such attachment, as the door edge attachment portion can be affixed to the edge of the door (with free access to the gap) prior to the door jamb attachment portion being affixed to the door jamb. Further, although the illustrated embodiments show the door jamb attachment portion being affixed to a surface of a door stop which extends substantially parallel to a surface of the closed door, embodiments can also be configured for attachment to a surface of a door jamb extending normal to a surface of a closed door. For example, referring to FIG. 3A, in an alternative embodiment, the door jamb attachment portion 108 can be rotated by about 90 degrees to the left or to the right and affixed to the surface 143. In such an embodiment, the hinge 122 can optionally be omitted.

While the above detailed description has shown, described and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others. Therefore, it should be clearly understood that the forms of the invention described herein are illustrative only and are not intended to limit the scope of the invention.

What is claimed is:

1. A door safety shield comprising:
a door attachment portion comprising a door edge portion and a cornering portion;
a substantially rigid portion operatively coupled to the door attachment portion;
a shield portion operatively coupled to the substantially rigid portion, the shield portion being substantially flexible in a first direction and being substantially inflexible in a second direction, the shield portion being configured to move in a rolling fashion away from a gap between the door and a door jamb at least when an external force is applied to the shield portion; and
a door jamb attachment portion operatively coupled to the shield portion.

2. The door safety shield of claim 1, wherein the cornering portion is configured to transfer detaching forces on the door edge portion to a surface of the door at least when the door is in an open position.

3. The door safety shield of claim 1, wherein a length of the shield portion is longer than a length of the substantially rigid portion.

4. The door safety shield of claim 1, wherein the shield portion comprises a tambour panel comprising a plurality of slats.

5. The door safety shield of claim 1, wherein the door edge portion and the cornering portion are hingedly coupled.

6. The door safety shield of claim 1, wherein the door edge portion and the cornering portion are fixedly coupled.

7. The door safety shield of claim 6, further comprising a connecting portion extending between the door attachment portion and the substantially rigid portion such that the substantially rigid portion is movable about the door attachment portion within an arc that is greater than 90°.

8. The door safety shield of claim 7, wherein the connecting portion is hingedly coupled to each of the door attachment portion and the substantially rigid portion.

9. A device for preventing injuries between a hinged door and a door jamb at a hinged side of the hinged door, the device comprising:
a door attachment portion configured for attaching to an edge of the door, the edge being generally normal to a plane of the door and located on the hinged side of the door;
a door jamb attachment portion configured for attaching to a surface of the doorjamb, the surface being generally parallel to a plane of the doorjamb;
a substantially rigid portion extending between the door attachment portion and the door jamb attachment portion, the substantially rigid portion being hingedly coupled to the door attachment portion;
a shield portion hingedly coupled to the door jamb attachment portion and extending toward the substantially rigid portion, the shield portion being configured to move in a rolling fashion as the door moves between an open and a closed position, at least when an external force is applied to the shield portion.

10. The device of claim 9, wherein the shield portion comprises an articulated region configured to be substantially flexible in a first direction and substantially inflexible in a second direction.

11. The device of claim 10, wherein the articulated region comprises a plurality of tambour slats.

12. The device of claim 11, wherein the substantially rigid portion comprises a tambour slat.

13. The device of claim 9, wherein the door attachment portion comprises a door edge portion and a cornering portion.

14. The device of claim 13, wherein the cornering portion extends generally normal to the door edge portion at least when the door is in a closed position.

15. The device of claim 13, wherein the cornering portion is configured to extend across a portion of a surface of the door at least when the door is in a closed position or a partially open position.

16. The device of claim 13, wherein the door edge attachment portion and the cornering portion are movably coupled.

17. The device of claim 13, wherein the door edge attachment portion and the cornering portion are fixedly coupled.

18. A door safety shield comprising:
means for bridging a gap between a door and a door jamb; at least a portion of the bridging means being configured to move in a rolling fashion away from a hinge of the door at least when an external force is applied to the bridging means;
first means for attaching the bridging means to the door;
first means for resisting detaching forces on the first means for attaching;
second means for attaching the bridging means to a surface of the door jamb; and
second means for resisting detaching forces on the second means for attaching.

19. The safety shield of claim 18, wherein the first means for attaching comprises a layer of the door.

20. The safety shield of claim 18, wherein the detaching forces on the first means for attaching include shear forces.

21. The safety shield of claim 18, wherein the detaching forces on the second means for attaching include normal forces.

22. The safety shield of claim 18, wherein the first resisting means comprises a portion of the shield configured to extend across a portion of a surface of the door at least when the door is in an open position.

23. The safety shield of claim 18, wherein the second resisting means comprises an articulated region of the shield.

24. The safety shield of claim 18, wherein the second resisting means comprises a hinged coupling of the bridging means and the second means for attaching.

25. A protective shield for a hinged door, the door being attached to a door jamb via a hinge, the protective shield comprising:
means for inhibiting buildup of static stress within the shield;
means for distributing detaching forces resulting from opening and closing of the door to one or more surfaces of the door and/or door jamb; and
means for distributing detaching forces resulting from an external force applied in a direction toward the hinge to one or more surfaces of the door and/or door jamb.

26. A method of preventing injuries at a hinged side of a hinged door, the method comprising:
providing a bridge configured to span a gap between the door and the door jamb, the bridge comprising a door attachment portion and a door jamb attachment portion;
attaching the door attachment portion to an edge of the door; and
attaching the door jamb attachment portion to an attachment surface of the door jamb,
wherein at least a portion of the bridge is configured to move in a rolling fashion away from a hinge of the door at least when an external force is applied to the bridge, and wherein at least a portion of the bridge is configured to contact a surface extending normal to the edge at least when the door is in a closed position, and further wherein at least a portion of the bridge is configured to contact a surface of the door jamb extending normal to the attachment surface at least when an external force is applied to the bridge in the direction of the normal surface.

27. A safety shield for a door hinged to a door jamb, the door having a surface and an edge, the safety shield comprising:
a door attachment portion comprising a door edge portion and a cornering portion, the door edge portion configured to be attached to the edge of the door, the cornering portion extending generally normal to the door edge portion and across at least a portion of the surface of the door at least when the door is in a closed position; and
a bridge operatively coupled to the door attachment portion.
